(19) United States
(12) Patent Application Publication
(10) Pub. No.: US 2024/0206500 A1
(43) Pub. Date: Jun. 27, 2024

(54) PET CHEW ARTICLE

(71) Applicant: IMS TRADING, LLC, Jamesburg, NJ (US)

(72) Inventors: Glen S. AXELROD, Colts Neck, NJ (US); Ajay GAJRIA, Monmouth Junction, NJ (US)

(21) Appl. No.: 18/396,853

(22) Filed: Dec. 27, 2023

Related U.S. Application Data
(60) Provisional application No. 63/477,249, filed on Dec. 27, 2022.

(51) Int. Cl. A23K 40/25; A23K 10/20; A23K 10/26; A23K 10/30; A23K 20/147; A23K 20/163; A23K 50/42

(52) U.S. Cl. CPC A23K 40/25; A23K 10/20; A23K 10/26; A23K 10/30; A23K 20/147; A23K 20/163; A23K 50/42

(57) ABSTRACT

A pet chew article, comprising the pet chew article formed of a plurality of physically engaged extrudates comprising a first extrudate and a second extrudate; wherein the first extrudate is porous and formed of a first extrudate composition containing starch; wherein the second extrudate is formed of a second extrudate composition containing meat; and wherein the first extrudate contains pores having a pore diameter in a range of 0.5 to 3 mm.

### CROSS-REFERENCE TO RELATED APPLICATIONS

This application claims the benefit of the filing date of U.S. provisional application Ser. No. 63/477,249 filed Dec. 27, 2023, which is incorporated by reference.

### FIELD

The present disclosure provides articles, in a form of pet chews and treats, which may be particularly formed of at least one expanded (porous) starch-containing composition, which may contain meat, and at least one starch-free composition containing meat. The at least one starch-containing composition and the at least one starch-free composition may be extruded in separate extruders as elongated extrudates (e.g. strands), and the resulting respective extrudate compositions physically (e.g. mechanically) engaged, such as with a braid, twist (helically wound) and/or knot.

### BACKGROUND

Pet chews produced from starch have been reported. For example, in U.S. Pat. No. 6,180,161, entitled “Heat Modifiable Edible Dog Chew”, it was reported that one could provide a dog chew formulated from a mixture of corn starch and potato starch, where the water level of the injection molded dog chew was controlled to levels of about 10.0% after molding. The dog chews were identified as offering a hardness-adjustable by subjecting the chews to microwave radiation.

In U.S. Pat. No. 6,126,978, entitled “Edible Dog Chew”, the is disclosed a heat expandable dog chew comprised primarily of injection molded potato starch, calcium carbonate, to which is added a fruit flavoring, a food coloring or a breath sweetener.

In U.S. Pat. No. 6,093,441, entitled “Heat Modifiable Dog Chew”, there is reported a dog chew formulated of peanut flour, casein and a vegetable starch carbohydrate, where the hardness is modifiable to suit a particular dog by the dog owner.

In U.S. Pat. No. 6,056,991, entitled “Turkey and Rice Dog Chew With Modifiable Texture”, there is reported a dog chew formulated primarily of turkey meal, rice meal, casein and starch carbohydrate, the hardness of which is modifiable to suit a particular dog by the dog owner.

In U.S. Pat. No. 8,677,943, entitled “Animal Chew Formed of Interwoven Strips of Edible Resin”, there is reported a woven chew toy for animals including one or more edible resins, such as rawhide, meat jerky, and starch, in strip form interwoven together to provide a planar article.

Accordingly, a need remains to provide edible pet chews that are formed of two different material compositions and which are physically engaged, such as with a braid, twist (helically wound) and/or knot.

### SUMMARY

A pet chew article, comprising: the pet chew article formed of a plurality of physically engaged extrudates comprising a first extrudate and a second extrudate; wherein the first extrudate is porous and formed of a first extrudate composition containing starch; wherein the second extrudate is formed of a second extrudate composition containing meat; and wherein the first extrudate contains pores having a pore diameter in a range of 0.5 to 3 mm.

In at least one embodiment, the first extrudate composition contains rice flour, pea protein and meat, and the meat of the first extrudate composition is at least one of red meat, white meat, chicken, duck and salmon.

In at least one embodiment, the starch of the first extrudate composition is at least one of corn starch and potato starch.

In at least one embodiment, the second extrudate composition does not contain starch; and the meat of the second extrudate composition is at least one of red meat, white meat, chicken, duck and salmon.

In at least one embodiment, the second extrudate is porous, and contains pores having a pore diameter in a range of 0.5 to 3 mm.

In at least one embodiment, the second extrudate composition contains rice flour, starch and pea protein.

In at least one embodiment, the first extrudate and the second extrudate are knotted at opposite ends of the pet chew article.

In at least one embodiment, the plurality of physically engaged extrudates comprise a third extrudate formed of a third extrudate composition.

In at least one embodiment, the first extrudate, the second extrudate and the third extrudate are braided along a length of the pet chew.

In at least one embodiment, the first extrudate, the second extrudate and the third extrudate are helically wound along a length of the pet chew.

In at least one embodiment, the third extrudate composition contains beefhide.

In at least one embodiment, the third extrudate composition contains meat.

In at least one embodiment, the third extrudate composition contains rice flour.

In at least one embodiment, the third extrudate composition contains sweet potato.

In at least one embodiment, the third extrudate is porous and contains pores having a pore diameter in a range of 0.5 to 3 mm; and the third extrudate composition contains starch.

In at least one embodiment, a method of forming a pet chew article is provided, the method comprising: extruding a first extrudate from a first extruder, wherein the first extrudate is porous and formed of a first extrudate composition containing starch; extruding a second extrudate from a second extruder, wherein the second extrudate is formed of a second extrudate composition containing meat; physically engaging the first extrudate and the second extrudate to each other; wherein the first extrudate contains pores having a pore diameter in a range of 0.5 to 3 mm; wherein the first extrudate exits the first extruder with a water content of 20-26% by weight of the first extrudate; and wherein the second extrudate exits the second extruder with a water content of 24-31% by weight of the second extrudate.

In at least one embodiment, the method further comprises vaporizing water in the first extruder during extrusion and under extrusion pressure to form a water vapor which is pressurized in the first extruder, and reducing the pressure on the water vapor in the first extrudate as the first extrudate exits the first extruder to expand the water vapor in the first extrudate which forms the pores in the first extrudate.

In at least one embodiment, the method further comprises introducing ingredients of a first formulation into the first extruder, wherein the ingredients include the starch of the first extrudate composition; and wherein the water vaporized in the first extruder is provided from within the ingredients of the first formulation.

In at least one embodiment, the method further comprises vaporizing water in the second extruder during extrusion and under extrusion pressure to form a water vapor which is pressurized in the second extruder, and reducing the pressure on the water vapor in the second extrudate as the second extrudate exits the second extruder to expand the water vapor in the second extrudate which forms pores in the second extrudate whereby the second extrudate is porous; introducing ingredients of a second formulation into the second extruder, wherein the ingredients include the meat of the second extrudate composition; and wherein the water vaporized in the second extruder is provided from within the ingredients of the second formulation.

In at least one embodiment, the method further comprises extruding a third extrudate from a third extruder, wherein the third extrudate is formed of a third extrudate composition containing meat; physically engaging the first extrudate and the second extrudate and the third extrudate to each other; vaporizing water in the third extruder during extrusion and under extrusion pressure to form a water vapor which is pressurized in the third extruder, and reducing the pressure on the water vapor in the third extrudate as the third extrudate exits the third extruder to expand the water vapor in the third extrudate which forms pores in the third extrudate whereby the third extrudate is porous; introducing ingredients of a third formulation into the third extruder, wherein the ingredients include the meat of the third extrudate composition; and wherein the water vaporized in the third extruder is provided from within the ingredients of the third formulation.

### FIGURES

The above-mentioned and other features of this disclosure, and the manner of attaining them, will become more apparent and better understood by reference to the following description of embodiments described herein taken in conjunction with the accompanying drawings, wherein:

FIG. 1 is a first pet chew article according to the present disclosure;

FIG. 2 is another pet chew article according to the present disclosure;

FIG. 3 is another pet chew article according to the present disclosure;

FIG. 4 is another pet chew article according to the present disclosure;

FIG. 5 is another pet chew article according to the present disclosure;

FIG. 6 is another pet chew article according to the present disclosure;

FIG. 7 is another pet chew article according to the present disclosure; and

FIG. 8 shows the pores of an exemplary extrudate/article according to the present disclosure.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

Throughout the present description, like reference numerals and letters indicate corresponding structure throughout the several views, and such corresponding structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable as suitable, and not exclusive.

The present disclosure provides articles, and more particularly extruded articles, in a form of edible pet chews and treats, which may be particularly formed of at least one expanded (porous) starch-containing composition, which may contain meat; and at least one starch-free composition (i.e. not containing starch) containing meat. As used herein, reference to an expanded composition is made reference to the feature that the material composition is expanded (made porous) during processing.

The at least one starch-containing composition and the at least one starch-free composition may be extruded in separate extruders as elongated extrudates (e.g. strands), and the resulting respective extrudates/strands, due to their conformity while still being above room temperature, physically (e.g. mechanically) engaged, such as with a braid, twist (helically wound) and/or knot. The starch of the at least one starch-containing composition is preferably sourced from potato starch. However, it is contemplated that the starch may be sourced from a variety of other sources, including corn, rice, wheat and tapioca.

During extrusion, by controlling the presence of moisture level (water) within the mixed ingredients (e.g., via barrel and die temperatures, pressures and screw speed hence shearing), one can form an extrudate composition, of either the starch-containing composition or the starch-free composition that expands and provides a porous structure and surface texture. Extrusion includes heating, melting and plasticization of the ingredients/composition. During extrusion, a portion of the water contained in the mixed ingredients/composition vaporizes (from liquid to steam) to form a vapor pressure under the extrusion temperatures and pressures. Thereafter, when the extrudate composition exits the extrusion die, and the extrusion pressures no longer exist on the extrudate composition (e.g. pressure drops to atmospheric pressure), the pressure exerted by the steam water vapor within the extrudate composition is also released, which causes the steam to expand and form voids (porosity/pores) in the extrudate composition.

By vaporizing a portion of the water content of the initial ingredients to steam during extrusion, and then releasing “steam” pressure upon extrusion to form voids in the extrudate composition, such may yield an extrudate composition from the ingredients from relatively low to relatively high amounts of expansion and internal porosity. Stated another way, the more water converted to steam, the lower the resultant density of the extrudate composition. With regards to density of the extrudate/composition, due to the porous structure, such may have a lower density as compared to an extrudate/composition which does not expand. The pores of the porous structure may have a pore size (uniform of non-uniform diameter) in a range of 0.5 mm to 3.0 mm, and more particularly 1 mm to 2.5 mm.

The starch-containing formulation/ingredients, as well as the resulting extrudate composition, may preferably comprise rice flour, corn starch, potato starch, pea protein, vegetable glycerin, chlorophyll, cochineal, sodium diacetate (a preservative and meat (e.g. red meat such as steer, buffalo, bison, cow, pig, sheep, lamb, deer, horse, boar, elk and goat, as farm raised, cattle or wild; white meat and poultry such as chicken, turkey and duck; and fish such as salmon). The meat may or may not include meat by-products, particularly soft-tissue internal organs, external organs (e.g. pizzle), vein, arteries, esophagus and intestine. As used herein, by-products are the non-rendered, clean parts, other than meat, derived from slaughtered mammals. It includes, but is not limited to, lungs, spleen, kidneys, brain, livers, blood, bone, partially de-fatted low temperature fatty tissue and stomachs and intestines freed of their contents. It does not include hair, horns, teeth and hoofs. Other additives may include attractants and flavorants.

The at least one starch-free formulation/ingredients, as well as the resulting extrudate composition, may preferably comprise beefhide (hide of a cow); sweet potato, rice flour, vegetable glycerin, sodium diacetate and meat (e.g. red meat such as steer, buffalo, bison, cow, pig, sheep, lamb, deer, horse, boar, elk and goat, as farm raised, cattle or wild; white meat and poultry such as chicken, turkey and duck; and fish such as salmon). The meat may or may not include meat by-products, particularly soft-tissue internal organs, external organs (e.g. pizzle), vein, arteries, esophagus and intestine. Other additives may include attractants and flavorants.

The extrudate of the starch-containing composition may then be physically (e.g. mechanically) engaged to the extrudate of the starch-free composition. For example, in one embodiment, the extrudate of the starch-containing composition is preferably mechanically engaged to the extrudate of the starch-free composition. The mechanical engagement may be in the form of a braid, twist (helically wound) and/or knot. As may therefore be appreciated, in one embodiment, one may combine one or a plurality of starch-containing extrudates with one or a plurality of starch-free extrudates. In other embodiments, all the extrudates of the article may be starch-containing extrudates or starch-free extrudates.

In another embodiment, one can preferably form, along with the starch-containing composition, a starch-free composition containing meat. In such regards, the extrudate of the starch-free composition, containing meat, may also have sufficient moisture (water) to expand and provide a porous structure and surface texture upon exiting the extrusion die. Again, during extrusion, by controlling the presence of moisture level (water) within the mixed ingredients (e.g., via barrel and die temperatures, pressures and screw speed hence shearing), one can form an extrudate composition that expands and provides a porous structure and surface texture. With regards to density of the extrudate/composition, due to the porous structure, such may have a lower density as compared to an extrudate/composition which does not expand. The pores of the porous structure may have a pore size (uniform of non-uniform diameter) in a range of 0.5 mm to 3.0 mm, and more particularly 1 mm to 2.5 mm.

One can therefore now conveniently arrange for the simultaneous extrusion of the starch-containing extrudate composition and the starch-free extrudate composition, with both providing a porous extrudate particularly formed by steam which expands within the respective composition to form pores within the composition upon the composition being subject to a pressure drop upon exiting the extrusion die.

As such extrudates are formed when exiting the extrusion die, and are in a relatively conformable state, it is contemplated that the starch-containing composition and starch-free composition, which both may contain meat may then be physically (e.g. mechanically) engaged. The two porous compositions may be mechanically engaged to one another in the form of a braid, twist (helically wound), or knot. Accordingly, in the broad context of the present disclosure, it is contemplated that one or a plurality of porous starch-containing compositions may be mechanically engaged with one or a plurality of porous starch-free compositions.

In addition, the meat-based formulation may optionally include other additives, such as attractants and flavorings.

The pet chew herein can therefore contain one or more porous extrudates of a starch-containing composition, particularly containing meat, mechanically engaged to one or more extrudates of starch-free composition, particularly containing meat, where the starch-free composition is optionally expanded and made porous. Such pet chew is contemplated to provide an engaging pet chew for an animal. In particular, it is contemplated that the ability to provide a porous starch-containing extrudate composition, particularly containing meat, and a starch-free extrudate composition, particularly containing meat and optionally porous, will draw interest from the animal for chewing and provide a relatively nutritious pet chew offering an engaging surface texture and porosity based upon both starch and meat components.

The following exemplary articles may provide pet chews according to the present disclosure.

### Example 1

Referring to FIG. 1, there is shown an example article 10a according to the present disclosure. As shown, the article 10a is an extrudate in a form of a braided elongated pet chew having three braided strands 12 (starch-containing), 14 (starch-containing, 16 (starch-free), and having ingredients as follows in Table 1:

TABLE 1

| Strand | Ingredients |
|---|---|
| 1 (12) | rice flour |
| | corn starch |
| | pea protein |
| | vegetable glycerin |
| | chicken |
| | sodium diacetate (preservative) |
| 2 (14) | repeat of strand 1 |
| 3 (16) | beefhide |

Strand 1 of article 10a is formed of an expanded (porous) starch composition.

### Example 2

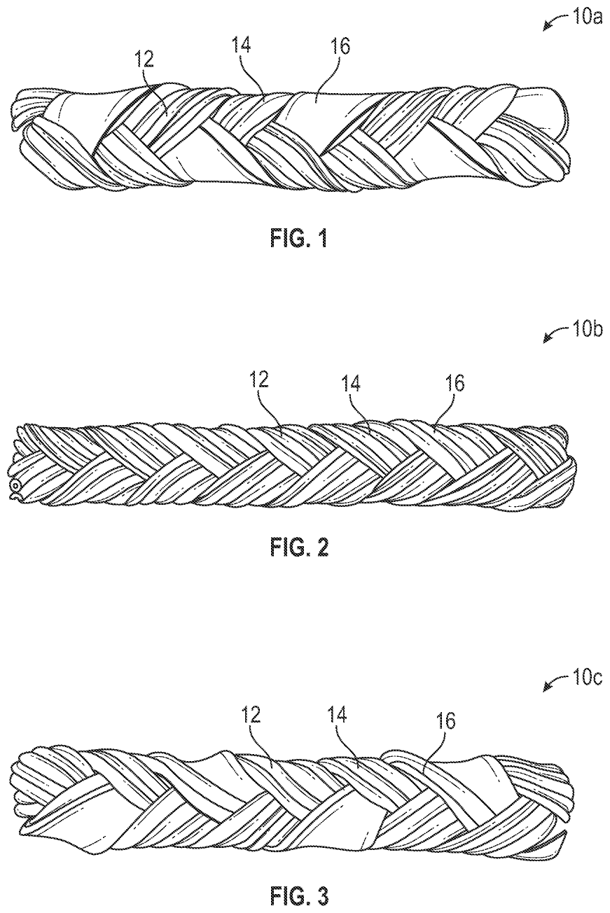

Referring to FIG. 2, there is shown an example article 10b according to the present disclosure. As shown, the article 10b is an extrudate in a form of a braided elongated pet chew having three braided strands 12 (starch-containing), 14 (starch-containing, 16 (starch-free), and having ingredients as follows in Table 2:

TABLE 2

| Strand | Formulation ingredients |
|---|---|
| 1 (12) | rice flour |
| | corn starch |
| | pea protein |
| | vegetable glycerin |
| | chicken |
| | sodium diacetate (preservative) |
| 2 (14) | repeat of strand 1 |
| 3 (16) | sweet potato |
| | rice flour |
| | Chicken |
| | vegetable glycerin |
| | sodium diacetate (preservative) |

### Example 3

Referring to FIG. 3, there is shown an example article 10c according to the present disclosure. As shown, the article 10c is an extrudate in a form of a braided elongated pet chew having three braided strands 12 (starch-containing), 14 (starch-containing, 16 (starch-free), and having ingredients as follows in Table 3:

TABLE 3

| Strand | Formulation ingredients |
|---|---|
| 1 (12) | rice flour |
| | corn starch |
| | pea protein |
| | vegetable glycerin |
| | Chicken |
| | sodium diacetate (preservative) |
| 2 (14) | repeat of strand 1 |
| 3 (16) | Chicken |
| | vegetable glycerin |
| | sodium diacetate (preservative) |

### Example 4

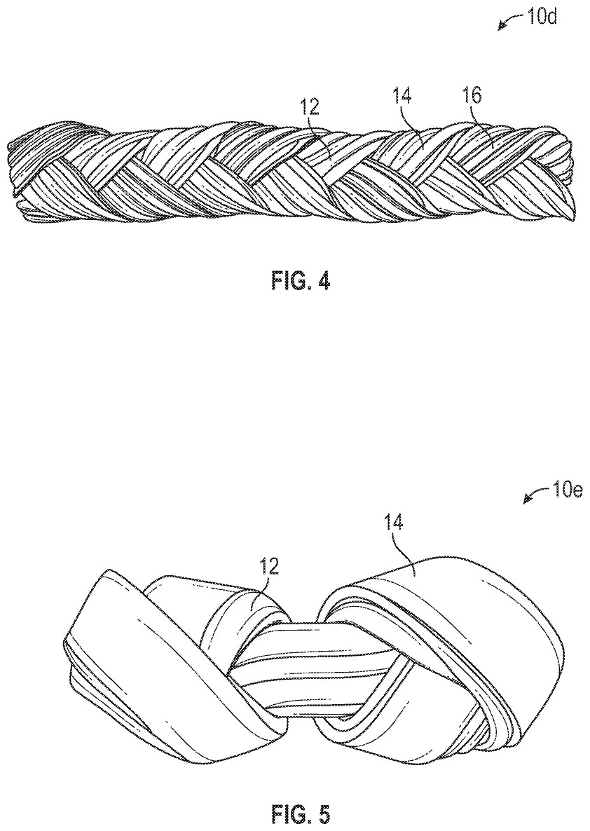

Referring to FIG. 4, there is shown an example article 10d according to the present disclosure. As shown, the article 10d is an extrudate in a form of a braided elongated pet chew having three braided strands 12 (starch-containing), 14 (starch-containing, 16 (starch-containing), and having ingredients as follows in Table 4:

TABLE 4

| Strand | Formulation ingredients |
|---|---|
| 1 (12) | rice flour |
| | corn starch |
| | pea protein |
| | vegetable glycerin |
| | chicken |
| | sodium diacetate (preservative) |
| 2 (14) | repeat of strand 1 |
| 3 (16) | potato starch |
| | rice flour |
| | chicken |
| | vegetable glycerin |
| | sodium diacetate (preservative) |

### Example 5

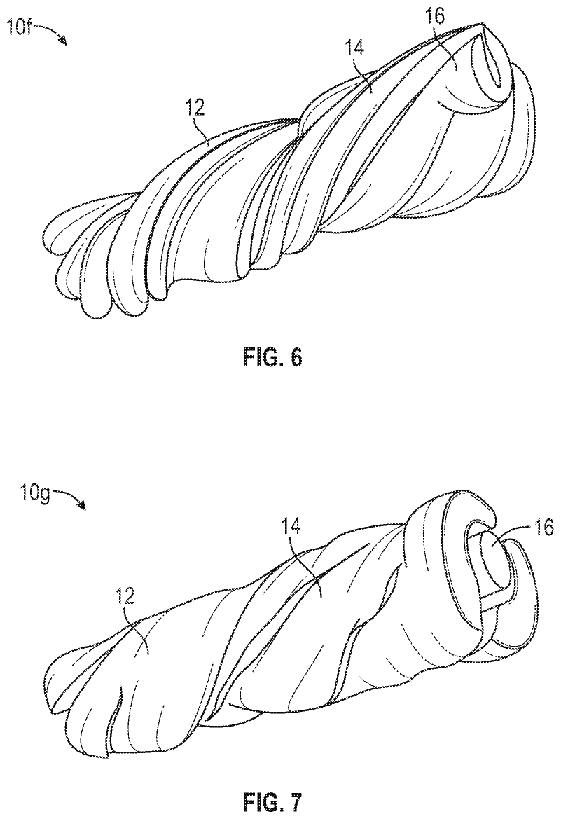

Referring to FIG. 5, there is shown an example article 10e according to the present disclosure. As shown, the article 10e is an extrudate in a form of a knotted elongated pet chew having two knotted strands 12 (starch-containing), 14 (starch-free), at opposite ends of the pet chew, and having ingredients as follows in Table 5:

TABLE 5

| Strand | Formulation ingredients |
|---|---|
| 1 | rice flour |
| | corn starch |
| | pea protein |
| | vegetable glycerin |
| | chicken |
| | sodium diacetate (preservative) |
| 2 | chicken |
| | vegetable glycerin |
| | sodium diacetate (preservative) |

### Example 6

Referring to FIG. 6, there is shown an example article 10f according to the present disclosure. As shown, the article 10f is an extrudate in a form of helically wound elongated pet chew having three helically wound strands 12 (starch-containing), 14 (starch-containing, 16 (starch-containing), and having ingredients as follows in Table 6:

TABLE 6

| Strand | Formulation ingredients |
|---|---|
| 1 | potato starch |
| | corn starch |
| | rice flour |
| | Chicken |
| | pea protein |
| | vegetable glycerin |
| | Chlorophyll |
| | sodium diacetate (preservative) |
| 2 | potato starch |
| | corn starch |
| | rice flour |
| | Chicken |
| | pea protein |
| | vegetable glycerin |
| | Cochineal |
| | sodium diacetate (preservative) |
| 3 | potato starch |
| | corn starch |
| | rice flour |
| | Chicken |
| | pea protein |
| | vegetable glycerin |
| | sodium diacetate (preservative) |

### Example 7

Referring to FIG. 7, there is shown an example article 10g according to the present disclosure. As shown, the article 10g is an extrudate in a form of helically wound elongated pet chew having three helically wound strands 12 (starch-containing), 14 (starch-containing, 16 (starch-containing), and having ingredients as follows in Table 7:

TABLE 7

| Strand | Formulation ingredients |
|---|---|
| 1 | potato starch |
| | corn starch |
| | rice flour |
| | Chicken |
| | pea protein |
| | vegetable glycerin |
| | chlorophyll |
| | sodium diacetate (preservative) |
| 2 | potato starch |
| | corn starch |
| | rice flour |
| | Chicken |
| | pea protein |
| | vegetable glycerin |
| | Cochineal |
| | sodium diacetate (preservative) |
| 3 | potato starch |
| | corn starch |
| | rice flour |
| | Chicken |
| | pea protein |
| | vegetable glycerin |
| | sodium diacetate (preservative) |

The ingredients of the starch-containing formulations/strands of Examples 1-7 may be mixed prior to being introduced to the hopper of the extruder. The ingredients may enter the extruder with a moisture (water) content in a range of 28-34% by weight, and more particularly 30-31% by weight. The ingredients may be heated to a temperature of 80-145° C. in the extruder and have a residence time in the extruder of 3-5 minutes. The starch-containing extrudate composition may then exit the extruder with a moisture (water) content of 20-26% by weight, and more particularly 22-25% by weight, at which time the extrudate composition may be physically (e.g. mechanically) engaged with another extrudate composition with a braid, twist (helically wound) and/or a knot. After being physically joined, the moisture (water) content of the starch-containing extrudate composition may be further decreased to 8-14% by weight, and more particularly 9-13% by weight, to aid increasing the rigidity of the extrudate composition.

Similar to the starch-containing formulations, the ingredients of the starch-free formulations/strands of Examples 1-3 and 5 may be mixed prior to being introduced to the hopper of the extruder. The ingredients may enter the extruder with a moisture (water) content in a range of 33-39% by weight, and more particularly 34-38% by weight. The ingredients may be heated to a temperature of 80-125° C. in the extruder and have a residence time in the extruder of 3-5 minutes. The starch-free extrudate composition may then exit the extruder with a moisture (water) content of 24-31% by weight, and more particularly 25-30% by weight, at which time the extrudate composition may be physically (e.g. mechanically) engaged with another extrudate composition with a braid, twist (helically wound) and/or a knot. After being physically joined, the moisture (water) content of the starch-free extrudate composition may be further decreased to 10-14% by weight, and more particularly 11-13% by weight, to aid increasing the rigidity of the extrudate composition.

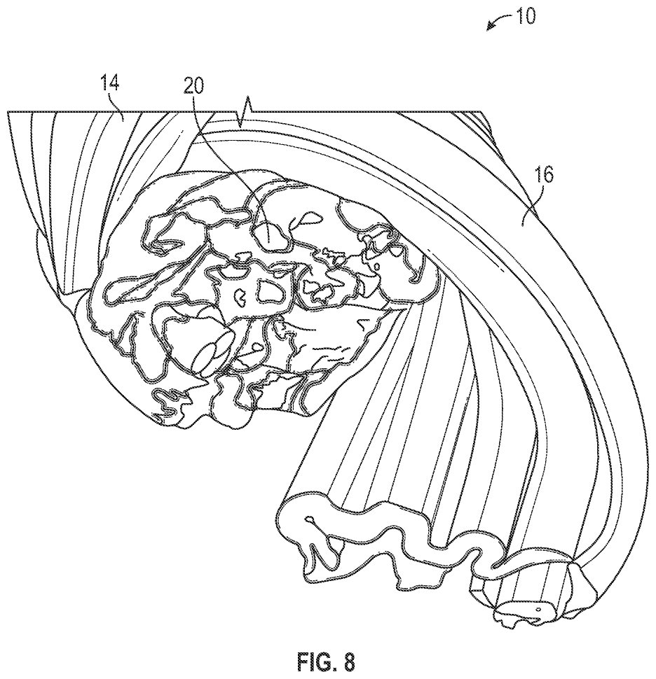

FIG. 8 shows a representative cross-section of an article 10 after the extrudates are physically joined and after decreasing the moisture (water) content. The pores 20 of the extrudate are also shown.

While preferred embodiments of the present disclosure have been described, it should be understood that various changes, adaptations and modifications can be made therein without departing from the spirit of the disclosure and the scope of the appended claims. The scope of the disclosure should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

What is claimed is:

1. A pet chew article, comprising:
the pet chew article formed of a plurality of physically engaged extrudates comprising a first extrudate and a second extrudate;
wherein the first extrudate is porous and formed of a first extrudate composition containing starch;
wherein the second extrudate is formed of a second extrudate composition containing meat; and
wherein the first extrudate contains pores having a pore diameter in a range of 0.5 to 3 mm.

2. The pet chew article of claim 1, wherein:
the first extrudate composition contains rice flour, pea protein and meat; and
the meat of the first extrudate composition is at least one of red meat, white meat, chicken, duck and salmon.

3. The pet chew article of claim 1, wherein:
the starch of the first extrudate composition is at least one of corn starch and potato starch.

4. The pet chew article of claim 1, wherein:
the second extrudate composition does not contain starch; and
the meat of the second extrudate composition is at least one of red meat, white meat, chicken, duck and salmon.

5. The pet chew article of claim 1, wherein:
the second extrudate is porous, and contains pores having a pore diameter in a range of 0.5 to 3 mm.

6. The pet chew article of claim 1, wherein:
the second extrudate composition contains rice flour, starch and pea protein.

7. The pet chew article of claim 1, wherein:
the first extrudate and the second extrudate are knotted at opposite ends of the pet chew article.

8. The pet chew article of claim 1, wherein:
the plurality of physically engaged extrudates comprise a third extrudate formed of a third extrudate composition.

9. The pet chew article of claim 8, wherein:
the first extrudate, the second extrudate and the third extrudate are braided along a length of the pet chew.

10. The pet chew article of claim 8, wherein:
the first extrudate, the second extrudate and the third extrudate are helically wound along a length of the pet chew.

11. The pet chew article of claim 8, wherein:
the third extrudate composition contains beefhide.

12. The pet chew article of claim 8, wherein:
the third extrudate composition contains meat.

13. The pet chew article of claim 8, wherein:
the third extrudate composition contains rice flour.

14. The per chew article of claim 8, wherein:
the third extrudate composition contains sweet potato.

15. The pert chew article of claim 8, wherein:
the third extrudate is porous and contains pores having a pore diameter in a range of 0.5 to 3 mm; and
the third extrudate composition contains starch.

16. A method of forming a pet chew article, comprising:
extruding a first extrudate from a first extruder, wherein the first extrudate is porous and formed of a first extrudate composition containing starch;
extruding a second extrudate from a second extruder, wherein the second extrudate is formed of a second extrudate composition containing meat;
physically engaging the first extrudate and the second extrudate to each other;
wherein the first extrudate contains pores having a pore diameter in a range of 0.5 to 3 mm;
wherein the first extrudate exits the first extruder with a water content of 20-26% by weight of the first extrudate; and
wherein the second extrudate exits the second extruder with a water content of 24-31% by weight of the second extrudate.

17. The method of claim 16, further comprising:
vaporizing water in the first extruder during extrusion and under extrusion pressure to form a water vapor which is pressurized in the first extruder, and reducing the pressure on the water vapor in the first extrudate as the first extrudate exits the first extruder to expand the water vapor in the first extrudate which forms the pores in the first extrudate.

18. The method of claim 17, further comprising:
introducing ingredients of a first formulation into the first extruder, wherein the ingredients include the starch of the first extrudate composition; and
wherein the water vaporized in the first extruder is provided from within the ingredients of the first formulation.

19. The method of claim 18, further comprising:
vaporizing water in the second extruder during extrusion and under extrusion pressure to form a water vapor which is pressurized in the second extruder, and reducing the pressure on the water vapor in the second extrudate as the second extrudate exits the second extruder to expand the water vapor in the second extrudate which forms pores in the second extrudate whereby the second extrudate is porous;
introducing ingredients of a second formulation into the second extruder, wherein the ingredients include the meat of the second extrudate composition; and
wherein the water vaporized in the second extruder is provided from within the ingredients of the second formulation.

20. The method of claim 18, further comprising:
extruding a third extrudate from a third extruder, wherein the third extrudate is formed of a third extrudate composition containing meat;
physically engaging the first extrudate and the second extrudate and the third extrudate to each other;
vaporizing water in the third extruder during extrusion and under extrusion pressure to form a water vapor which is pressurized in the third extruder, and reducing the pressure on the water vapor in the third extrudate as the third extrudate exits the third extruder to expand the water vapor in the third extrudate which forms pores in the third extrudate whereby the third extrudate is porous;
introducing ingredients of a third formulation into the third extruder, wherein the ingredients include the meat of the third extrudate composition; and
wherein the water vaporized in the third extruder is provided from within the ingredients of the third formulation.
